(19) United States
(12) Patent Application Publication
(10) Pub. No.: US 2021/0374710 A1
(43) Pub. Date: Dec. 2, 2021

(54) METHOD AND SYSTEM FOR PASSENGER TRANSPORT

(71) Applicant: AUDI AG, Ingolstadt (DE)

(72) Inventor: Marcus KUEHNE, Beilngries (DE)

(73) Assignee: AUDI AG, Ingolstadt (DE)

(21) Appl. No.: 17/051,634

(22) PCT Filed: Sep. 7, 2018
(86) PCT No.: PCT/EP2018/074170

§ 371 Date: Oct. 29, 2020

(30) Foreign Application Priority Data
Apr. 30, 2018 (DE) 10 2018 206 655.8

(51) Int. Cl. G06Q 20/22; G01C 21/34; G06Q 10/02; G06Q 50/30

(52) U.S. Cl. CPC G06Q 20/29; G01C 21/3438; G06Q 50/30; G01C 21/3484; G06Q 10/02

(57) ABSTRACT

A user books passenger transportation in a ride sourcing system that selects a motor vehicle from a fleet of vehicles belonging to a passenger transportation provider. The system assigns the selected motor vehicle to the passenger transportation booking of the user and registers an entertainment option booking as assigned to the passenger transportation booking of the user. This enables the user to play an entertainment option, corresponding to the entertainment option booking, by an output device in the selected motor vehicle while the user is being transported as a passenger in the selected motor vehicle.

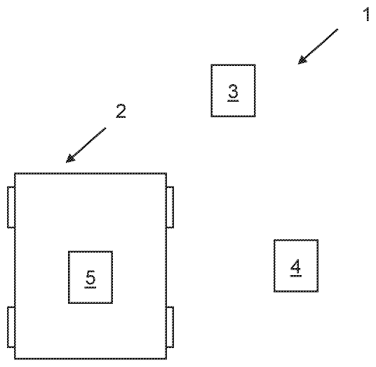

### CROSS REFERENCE TO RELATED APPLICATIONS

This application is a U.S. national stage of International Application No. PCT/EP2018/074170, filed on Sep. 7, 2018. The International Application claims the priority benefit of German Application No. 10 2018 206 655.8 filed on Apr. 30, 2018. Both the International Application and the German Application are incorporated by reference herein in their entirety.

### BACKGROUND

Described below are a method and system for passenger transportation within the scope of ride sourcing.

Ride sourcing using motor vehicles, in particular including commercial ride sourcing, is becoming increasingly widespread. Ride sourcing of this kind is often also referred to as ride hailing which is a mobility form that has arisen in the 21^{st} century. Ride sourcing involves primarily people living in urban areas being able to find and book a usually private ride via various app providers, wherein commercial rides can also be booked.

DE 2014 224 481 A1 describes remote control of vehicle functionalities by a mobile terminal. A rental vehicle can be reserved by the mobile terminal. Following this, for example, headlamps of the motor vehicle can be activated in a remotely controlled manner.

DE 10 2014 203 717 A1 describes a method for data transmission. A vehicle interface is connected to a mobile terminal, wherein entertainment contents are paid for via the mobile terminal and displayed on a display in a vehicle.

DE 11 2012 006 863 T5 describes handling an incoming telephone call. The incoming telephone call on a mobile radio device is displayed by a display device of a rear seat entertainment system of a motor vehicle.

### SUMMARY

Described below is a technical solution by which users of ride sources can be provided with entertainment options in a particularly simple manner. This is achieved by methods and also by a system for passenger transportation within the scope of ride sourcing.

In the method described below, a passenger transportation booking of a user is initially registered. A motor vehicle is then selected from a fleet of vehicles belonging to a passenger transportation provider and the selected motor vehicle is assigned to the passenger transportation booking. The passenger transportation provider may be a provider of the ride hailing options mentioned at the outset. Furthermore, an entertainment option booking, which is assigned to the passenger transportation booking, of the user is registered. An entertainment option, which corresponds to the entertainment option booking, is played back by an output device in the motor vehicle while the user is being transported as a passenger by the motor vehicle.

As mentioned at the outset, so-called ride hailing or ride sourcing is becoming increasingly widespread. Ride hailing involves a user being able to book a motor vehicle, typically by using an app on a smartphone. The booked motor vehicle comes to the user, the user enters and is taken by a driver or else fully autonomously by the booked motor vehicle to the destination defined by the user. Here, the is based on the finding that the entertainment options available in ride sources of this kind have been relatively limited to date. In particular, it has been found that there is no special entertainment option for ride sources of this kind.

By the method described herein, it is possible for the user to be able to book into entertainment options in accordance with their own priority, so that the user can spend the trip utilizing the entertainment option booked by them or use the entertainment option during the trip.

The entertainment options may be a wide variety of entertainment options. Therefore, it is possible, for example, for the user to be able to book into feature films or series. It is also possible for the user to be able to book into a wide variety of games for entertainment which the user can play alone or else, for example, online with other users. It is also possible, for example, for the trip to be used to take a sightseeing tour by way of the user putting on, for example, augmented reality glasses by which a wide variety of information relating to attractions on the route is overlaid as augmented reality. It goes without saying that the entertainment option which can be booked into can also include acoustic entertainment options.

By the method described herein, it is possible for a user of a ride source to be able to select and book a wide variety of entertainment options before or else during the trip and ultimately consume the entertainment options while being transported as a passenger.

An advantageous embodiment provides that the entertainment option booking and the passenger transportation booking are made in a joint booking process, wherein the selection of the motor vehicle is made in such a way that the motor vehicle has an output device which is designed for playing back the entertainment option. For example, it is therefore possible for the fleet of vehicles belonging to the passenger transportation provider to have a large number of different motor vehicles which are equipped with different output devices in different expansion stages. Within the scope of the passenger transportation booking, the user can also book the entertainment option desired by them at the same time. The advantage of this is that the selection of the motor vehicle and assignment of the motor vehicle to the booking of the user can always be made such that the motor vehicle also has an output device which is designed to play back the relevant entertainment option. In this way, it is possible to ensure that the user can also consume the form of entertainment booked by them during the passenger transportation booked by them in every case.

A further advantageous embodiment provides that the passenger transportation booking is registered by an app, which is installed on a mobile terminal, and is transmitted to a server device of the passenger transportation provider. Therefore, the user can call up the app in a simple manner, for example via their smartphone, and make the passenger transportation booking. In this way, it is also possible for the user to make their entertainment option booking, for example, during the course of the passenger transportation booking or else thereafter in a wholly convenient manner. Therefore, the user can make the passenger transportation booking, in particular including the entertainment option booking, in a wholly convenient and simple manner virtually anywhere—provided that their smartphone has Internet access available at that time. For example, the current location of the smartphone can also be transmitted within the scope of the passenger transportation booking, so that the passenger transportation provider equally also has the collection address for the user available.

According to a further advantageous embodiment, it is provided that different bookable entertainment options are offered during the passenger transportation booking. If the passenger transportation booking is made, for example, via a smartphone app, the available entertainment options can also be inserted within the scope of the booking process for the actual trip. The user can then directly identify which entertainment options they can book into for passenger transportation, if so desired. In addition, it is also possible for different bookable entertainment options to be offered during the trip. Therefore, the bookable entertainment options can be displayed to the user for selection, for example, by one or another display devices in the motor vehicle. This option can also be displayed by the app on the user's smartphone. Therefore, the user can select different entertainment options during the trip and then allow them to be output even after the passenger transportation booking. The entertainment option which is selected and booked during the trip may then be billed together with the actual passenger transportation, this being particularly convenient for the user. Provision can also be made for advertisement contents to be displayed during the trip if the user so wishes. In return, the advertiser allowing the advertisement contents to be displayed covers some or all of the costs of the trip and/or of the booked entertainment option. Furthermore, it is also possible for a digital map to be displayed to the user during the trip—for example via a display in the vehicle or else via electronic data glasses which are worn by the user. In this case, the position of the motor vehicle and also a destination which is selected by the user are displayed. Therefore, the user can monitor how and whether the motor vehicle is approaching the desired destination at any time during the trip.

In a further advantageous refinement, it is provided that bookable entertainment options which are matched to a length and/or duration of a route and/or to route characteristics during the passenger transportation booking are offered. The advantage is, in particular, that the entertainment options are matched in a suitable manner to the duration, length and/or characteristics of the route, so that the user can also complete a film, a series, a computer game or the like during the passenger transportation in every case for example. If it is additionally known, for example on the basis of the route characteristics, that the route is very hilly and winding, matching computer games in which the user likewise experiences severe up and down movements and also sideways movement in the virtual world can be displayed to the user for example. As a result, a particularly immersive gaming experience can be provided. In other words, it is therefore possible for the entertainment options which can be booked into to be filtered in a manner matched to the length, duration and/or characteristics of the route. Therefore, entertainment options which are particularly well-matched to the passenger transportation are displayed and offered to the user.

A further advantageous embodiment provides that the entertainment option is displayed by electronic data glasses provided in the motor vehicle, in particular virtual reality glasses, augmented reality glasses or mixed reality glasses. By virtual reality glasses, films or else computer games can be displayed in a particularly realistic manner for example. By augmented reality glasses, it is possible, for example, for the user to be able to experience an augmented sightseeing tour or the like during the trip. By mixed reality glasses, it is possible, for example, for the user to play a computer game and also at least partially still perceive their real environment, wherein it is possible in this way, for example, for several users to be able to jointly use a motor vehicle for passenger transportation and be able to interact with one another as part of a computer game for example. In addition, it is also possible for the booked entertainment option to be played back, for example, via an entirely conventional display, for example a rear seat entertainment system, of the motor vehicle in question.

In a further advantageous refinement, it is provided that an interface for connection of the electronic data glasses is provided in the motor vehicle or the electronic data glasses are permanently connected in the motor vehicle. In the first case, it is possible, for example, for the user to take their own electronic data glasses for the trip and be able to connect these to the interface in the motor vehicle. As an alternative, it is also possible for at least one pair of electronic data glasses to be permanently connected and installed in the motor vehicle. The latter case has the advantage that the user does not need to bring any equipment for the trip in order to be able to consume the entertainment option preferred or booked by them. However, as an alternative, it may also be possible for the user to be able to connect their own electronic data glasses in the motor vehicle in order to employ these to use the entertainment option.

A further advantageous embodiment provides that motion data of the motor vehicle are included in a presentation of the entertainment option in order to prevent the user of the electronic data glasses from becoming nauseous. When consuming the booked entertainment option by using the electronic data glasses, the optical impressions may lead to a certain discrepancy between the optical sensory impressions and the impressions suggested to the user by their sense of balance being able to be created the user of the electronic data glasses. This could result in a feeling of nausea. In order to counteract this, which is often also referred to as simulator sickness, motion data of the motor vehicle may be included in the presentation of the entertainment option. Therefore, for example, visual cues which characterize the movement of the motor vehicle can also be inserted. In this way, it is possible to reliably prevent the user of the electronic data glasses from becoming nauseous. For example, it is possible for motion data of the motor vehicle to be transmitted to the electronic data glasses, which also incorporate contents corresponding to the motion data into the entertainment option, via an on-board diagnosis interface or via other interfaces of the motor vehicle. As an alternative or in addition, it is also possible the, for example, sensors of the electronic data glasses themselves to be used in order to register movements of the motor vehicle. In the first case, particularly exact motion data of the motor vehicle can be provided in order to counteract possible nausea of the user. In the second case, it is particularly simple to generate the motion data since the motion data do not first have to be transmitted from the motor vehicle to the electronic data glasses.

According to a further advantageous embodiment, it is provided that costs of the passenger transportation booking and the entertainment option booking are billed jointly. In this way, the user can be billed for their actual journey and the use of the entertainment option in a particularly simple manner.

The system described herein for passenger transportation within the scope of ride sourcing is designed to carry out the method described herein or an advantageous embodiment of the method. Advantageous refinements of the method are to be considered to be advantageous refinements of the system, and vice versa.

Further aspects, advantages, features and details can be found in the following description of exemplary embodiments and with reference to the drawing. The features and combinations of features which are mentioned above as well as the features and combinations of features which are mentioned below and/or shown in the FIGURE alone can be used not only in the respectively specified combination but also in other combinations or on their own, without departing from the scope of the invention.

### BRIEF DESCRIPTION OF THE DRAWINGS

In the drawing, the single FIGURE shows a schematic block diagram of a system for passenger transportation within the scope of ride sourcing.

### DETAILED DESCRIPTION

Reference will now be made in detail to the preferred embodiments, examples of which are illustrated in the accompanying drawings, wherein like reference numerals refer to like elements throughout.

A system 1 for passenger transportation within the scope of ride sourcing is shown in a highly schematic illustration in the single FIGURE. The system 1 has a plurality of motor vehicles 2, wherein only one is illustrated. The system 1 additionally further includes a server device 3 of a passenger transportation provider. In addition, the system 1 further includes a plurality of smartphones 4 on which an app by which different users can book ride sources is installed.

A passenger transportation booking of a user is initially registered by the smartphone 4 on which a suitable app via which the booking can be made is installed. The registered passenger transportation booking is transmitted to the server device 3 by the smartphone 4. It goes without saying that other booking options are also conceivable. Therefore, it is possible, for example, for the person to make the passenger transportation booking, for example, in a browser-based manner or else in other ways.

One of the motor vehicles 2 of the fleet of vehicles belonging to the passenger transportation provider is selected and the selected motor vehicle 2 is assigned to the passenger transportation booking. In addition, an entertainment option booking, which is assigned to the passenger transportation booking, of the user is registered. This can once again be done via the app which is installed on the smartphone 4.

The motor vehicle 2 then collects the user and drives them to their desired destination. During this process, an entertainment option which corresponds to the entertainment option booking is output or played back by an output device 5, in the motor vehicle 2, while the user is being transported as a passenger.

It is possible for the entertainment option booking and the passenger transportation booking to be made in a joint booking process, such as by using the smartphone 4. In this case, the selection of the motor vehicle 2 from the entire fleet of vehicles belonging to the passenger transportation provider is made in such a way that the motor vehicle 2 also has an output device 5 which is designed for playing back the booked entertainment option. Different bookable entertainment options may be displayed or offered during the passenger transportation booking, for example by the smartphone 4. In so doing, it is possible for the entertainment options to already be pre-filtered, specifically so as to match a length or else duration of a route of the desired passenger transportation. In addition, it is also possible for the entertainment options to be filtered in respect of how well they match specific route characteristics of the passenger transportation.

The booked entertainment option can be displayed by electronic data glasses, for example in the form of virtual reality glasses, augmented reality glasses or mixed reality glasses. Here, it is possible for the output device 5 in the motor vehicle 2 to be permanently installed electronic data glasses. Therefore, the user who has booked the passenger transportation within the scope of ride sourcing does not have to bring along their own output means. As an alternative, it is also possible for some or all of the motor vehicles 2 of the fleet of vehicles in question to have an interface, not illustrated in any detail here, for connection of the electronic data glasses. Therefore, it is possible for respective users to be able to bring along their own electronic data glasses for the trip and connect the electronic data glasses in the motor vehicle 2 in order to consume their booked entertainment option.

In order to prevent the respective users of the electronic data glasses in the motor vehicle 2 from becoming nauseous, motion data of the motor vehicle 2 may be included in a presentation of the booked entertainment option. Therefore, discrepancies between the visual perception of the entertainment option and feedback from the respective organ of balance of the user of the electronic data glasses can be resolved. So-called simulator sickness can therefore be counteracted. Here, the electronic data glasses themselves can have suitable sensors for registering movements of the motor vehicle 2 and generating motion data which are included in the presentation of the entertainment option in question from the movements. As an alternative or in addition, it is also possible for the movement data to be provided directly by the motor vehicle 2 and transmitted to the electronic data glasses. This can be done via cables or else in a cable-free or wire-free manner.

The costs of the passenger transportation and the entertainment option booking or entertainment playback can be billed jointly. Therefore, it is possible, for example, for user data and bank account data to be stored in the app of the respective smartphone 4, so that trips and entertainment options which are booked with the passenger transportation provider can be billed in one step, for example when the trip is complete.

By the described method and the system 1, it is possible for users when sourcing a ride to be able to select and consume entertainment options which match the respective trip in a simple and convenient manner. The motor vehicles 2 of the fleet of vehicles may also be autonomous vehicles, so that the autonomous vehicles can take respective users to their respective destinations in a driverless manner. As an alternative or in addition, it is also possible for the motor vehicles 2 to be moved in a conventional manner by drivers.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for passenger transport obtained by ride sourcing, comprising:
registering a passenger transportation booking of a user;
selecting a motor vehicle from among a fleet of vehicles belonging to a passenger transportation provider;
assigning the motor vehicle to the passenger transportation booking;
offering bookable entertainment options, matched to at least one of length of a route, duration of the route and route characteristics, during the passenger transportation booking;
registering an entertainment option booking, selected by the user from among the bookable entertainment options, as assigned to the passenger transportation booking of the user; and
playing back an entertainment option, corresponding to the entertainment option booking, by an output device in the motor vehicle while the user is being transported as a passenger by the motor vehicle.

12. The method according to claim 11,
wherein the entertainment option booking and the passenger transportation booking are made in a joint booking process, and
wherein the selecting of the motor vehicle selects one of the vehicles in the fleet having an output device designed for providing the entertainment option booking.

13. The method according to claim 12, wherein the registering of the passenger transportation booking includes an app, installed on a mobile terminal, transmitting the passenger transportation booking to a server device of the passenger transportation provider.

14. The method according to claim 12, wherein the entertainment option is displayed in the motor vehicle, by one of virtual reality glasses, augmented reality glasses and mixed reality glasses.

15. The method according to claim 14, wherein the motor vehicle includes at least one of an interface for connection of electronic data glasses and the electronic data glasses permanently connected in the motor vehicle.

16. The method according to claim 15, wherein motion data of the motor vehicle are included in a presentation of the entertainment option to prevent the user of the electronic data glasses from becoming nauseous.

17. The method according to claim 11, wherein the offering of the bookable entertainment options occurs during the passenger transportation booking.

18. The method according to claim 11, wherein costs of the passenger transportation booking and the entertainment option booking are billed jointly.

19. The method according to claim 11, wherein the registering of the passenger transportation booking includes an app, installed on a mobile terminal, transmitting the passenger transportation booking to a server device of the passenger transportation provider.

20. The method according to claim 11, wherein the entertainment option is displayed in the motor vehicle, by one of virtual reality glasses, augmented reality glasses and mixed reality glasses.

21. A system for passenger transport by a passenger transportation provider of ride sourcing that maintains a fleet of vehicles, comprising
a server configured to
provide a passenger transportation booking to a user,
offer bookable entertainment options, matched to at least one of length of a route, duration of the route and route characteristics,
register the passenger transportation booking of the user and an entertainment option booking, selected by the user from among the bookable entertainment options, as assigned to the passenger transportation booking,
select a motor vehicle from among the vehicles in the fleet of the passenger transportation provider, and
assign the motor vehicle to the passenger transportation booking; and
entertainment delivery systems in at least some of the vehicles in the fleet, including the motor vehicle selected by the server, configured to play back an entertainment option identified in the entertainment option booking while the user is being transported as a passenger by the motor vehicle.

22. The system according to claim 21, wherein the server is further configured to
offer the bookable entertainment options during the passenger transportation booking by the user, and
select the motor vehicle based capability of the motor vehicle to play back the entertainment option.

23. The system according to claim 21, wherein the system communications with mobile terminals, and
wherein the server is further configured to receive the passenger transportation booking from an app installed on one of the mobile terminals.

24. The system according to claim 23, wherein the entertainment delivery systems include at least one of virtual reality glasses, augmented reality glasses and mixed reality glasses permanently connected inside the motor vehicle.

25. The system according to claim 23, wherein the entertainment delivery systems include an interface for connection of at least one of virtual reality glasses, augmented reality glasses and mixed reality glasses.

26. The system according to claim 21, wherein the system communications with mobile terminals, and
wherein the server is further configured to receive the passenger transportation booking from an app installed on one of the mobile terminals.

27. The system according to claim 21, wherein the entertainment delivery systems include at least one of virtual reality glasses, augmented reality glasses and mixed reality glasses permanently connected inside the motor vehicle.

28. The system according to claim 21, wherein the entertainment delivery systems include an interface for connection of at least one of virtual reality glasses, augmented reality glasses and mixed reality glasses.
